(19) United States
(12) Patent Application Publication
(10) Pub. No.: US 2011/0126445 A1
(43) Pub. Date: Jun. 2, 2011

(54) Adjustable Bobber Assembly

(76) Inventor: David G. Scholfield, Wind Lake, WI (US)

(21) Appl. No.: 12/953,592

(22) Filed: Nov. 24, 2010

Related U.S. Application Data
(60) Provisional application No. 61/263,972, filed on Nov. 24, 2009.

(51) Int. Cl. A01K 97/01; A01K 93/02; A01K 97/12

(52) U.S. Cl. 43/17; 43/17.5

(57) ABSTRACT

An adjustable bobber assembly is provided that includes a main body adapted to be secured to a fishing pole, a pivot arm pivotally secured to the main body, a locking clip secured to the main body to lock the pivot arm in place on the main body, and an indicator adjustably secured to the pivot arm and engageable with a fishing line on the fishing pole.

### CROSS-REFERENCE TO RELATED APPLICATIONS

This application claims priority from U.S. Provisional Application Ser. No. 61/263,972, filed on Nov. 24, 2009, the entirety of which is expressly incorporated by reference herein.

### FIELD OF THE INVENTION

The present invention relates generally to signaling devices for ice fishing, and in particular to adjustable balance devices for use with lures of differing weights.

### BACKGROUND OF THE INVENTION

In ice fishing, specialized poles and rigs may be used to signal the taking of a lure by a fish. Poles are often used which rest on the ice, free of contact with the angler's hands. Some species of fish, for example perch, may exert only minute forces on the fishing line when making contact. The force of the fish tugging on the line is often so faint as to produce an imperceptible movement of the fishing pole that, when the angler does not have the rod in his hands, goes unnoticed.

There are many tip-up and other signaling devices for ice-fishing, but these usually require a substantial force on the line to produce the signaling phenomenon, and often are not well suited for light-hitting panfish.

Free-standing tip-ups such as that disclosed in U.S. Pat. No. 1,808,736 employing spherical weights running freely in a central bore as a counterweight to the line and lure in the water are known to the art. Devices for indicating fish bites such as that disclosed in U.S. Pat. No. 3,058,249 which are mountable on a standard fishing pole are also known to the art. Because different lures and lengths of fishing line will have differing weights, to be useful in a variety of circumstances a counterbalanced signaling apparatus should be infinitely adjustable.

What is needed is a simple bite signal indicator for ice fishing which may be adjustably balanced and which is sensitive to low-intensity pulls by fish.

One example of a device of this type is illustrated in U.S. Pat. No. 5,115,590, which is incorporated by reference herein in its entirety. The bobber disclosed in this reference includes a spherical weight disposed within a cylindrical tube that provides the adjustable balancing function for the bobber, i.e., that balances the bobber in a substantially horizontal position or to unbalance the assembly so that it assumes a vertically inclined position. However, even in this configuration, the bobber employs a multitude of parts that require more involved manufacturing and assembly of the bobber than is desired.

Therefore, it is desirable to develop a bobber for use with a fishing rod that can provide the desired visual indication of a strike by a fish on the fishing line where the bobber has a construction that can be assembled and used with the rod in a simple and easy to employ manner.

### SUMMARY OF THE INVENTION

According to one aspect of the present invention, a bobber is provided that can be adjustably mounted to a fishing pole to provide a visual indication of a fish striking the line on the pole. The bobber includes a main body that is attached to the fishing pole, and a pivoting indicator attached to the main body. The indicator is adjustably mounted to the main body such that the indicator can be positioned at in variety of configurations with respect to the main body to vary the amount of force required to activate the indicator. Opposite the main body the indicator is secured to a counterweight that assists in providing the balancing function of the indicator.

According to another aspect of the present invention, the indicator and optionally other suitable portions of the bobber can be formed from a luminescent material to enhance the visibility of the indicator.

According to still another aspect of the present invention, the bobber has a simple construction to facilitate construction and assembly of the bobber, and does not include any unsecured parts in the bobber assembly that could inadvertently trigger the indicator on the bobber.

Numerous other aspects features and advantages of the present invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is an isometric view of a bobber assembly constructed according to the present invention secured to a fishing pole;

FIG. 2 is a front plan view of the bobber assembly of FIG. 1;

FIG. 3 is a rear plan view of the bobber assembly of FIG. 1;

FIG. 4 is a front isometric view of a main body of the bobber assembly of FIG. 1;

FIG. 5 is a rear isometric view of the main body of FIG. 4;

FIG. 6 is an upper front isometric view of a locking clip secured to the main body in the bobber assembly of FIG. 1;

FIG. 7 is a lower front isometric view of the locking clip of FIG. 6; and

FIG. 8 is a rear isometric view of the locking clip of FIG. 6.

### DETAILED DESCRIPTION OF THE INVENTION

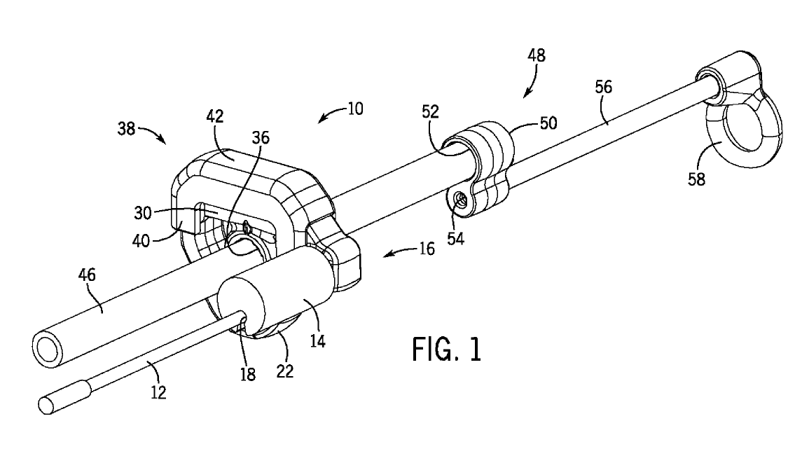

With reference now to the drawing figures in which like reference numerals designate like parts throughout the disclosure, a bobber assembly constructed according to one embodiment of the present invention is disclosed generally at 10 in FIG. 1. The bobber assembly 10 is affixed to a fishing rod 12 in either a releasable or fixed manner using a sleeve 14 positioned on a main body 16 of the assembly 10. The sleeve 14 can be formed of any suitable material, such as a plastic, silicone or rubber material, but is preferably formed of a soft rubber material to facilitate the attachment of the sleeve 14 to the rod 12. The rod 12 can be slid though a central channel 18 formed within the sleeve 14, with the passage 18 being formed with a suitable cross-sectional shape, e.g., circular or square, among others, to effectively hold the rod 12 within the sleeve 14. To assist the placement of the rod 12 within the sleeve 14, the sleeve 14 may also have a slit (not shown) formed lengthwise through the sleeve 14 to intersect the channel 18. The slit enables opposed portions of the sleeve 14 to deflect around the rod 12, allowing the rod 12 to pass through the slit and into the channel 18, where the resilient nature of the sleeve 14 urges the opposed portions together around the rod 12 to hold the rod 12 within the sleeve 18.

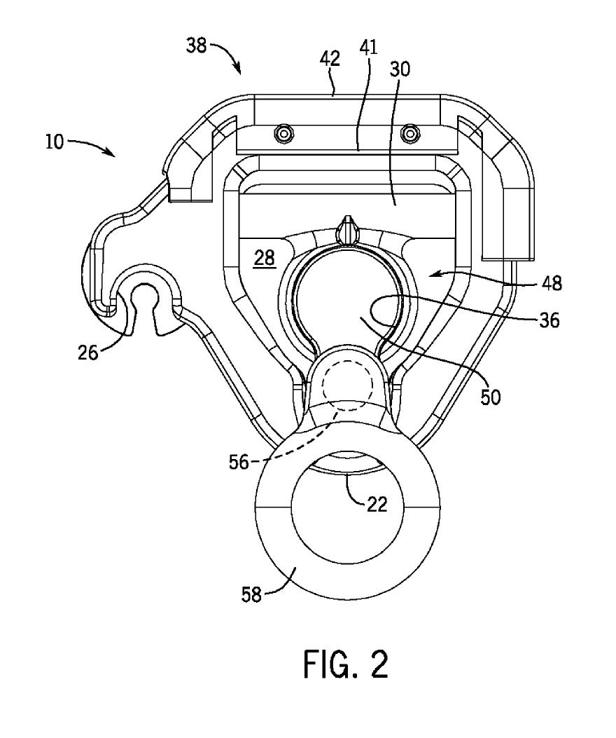

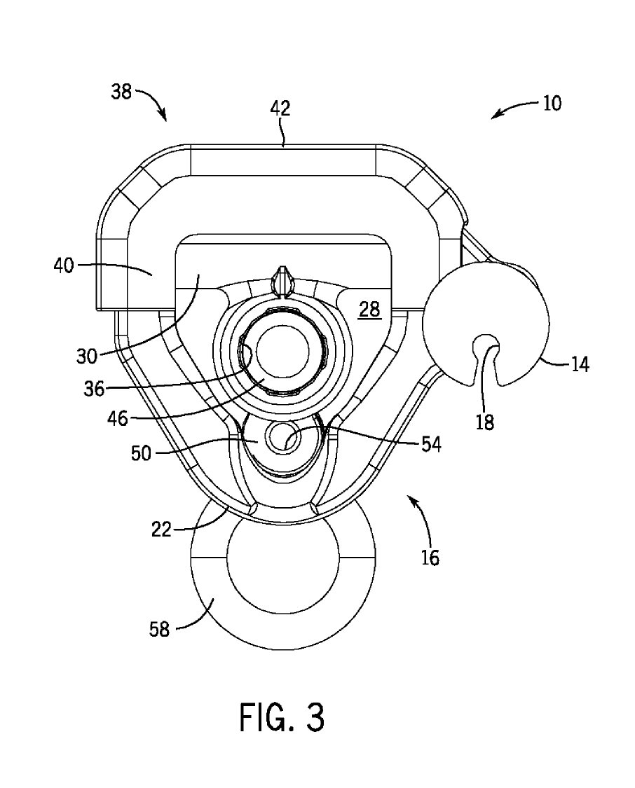

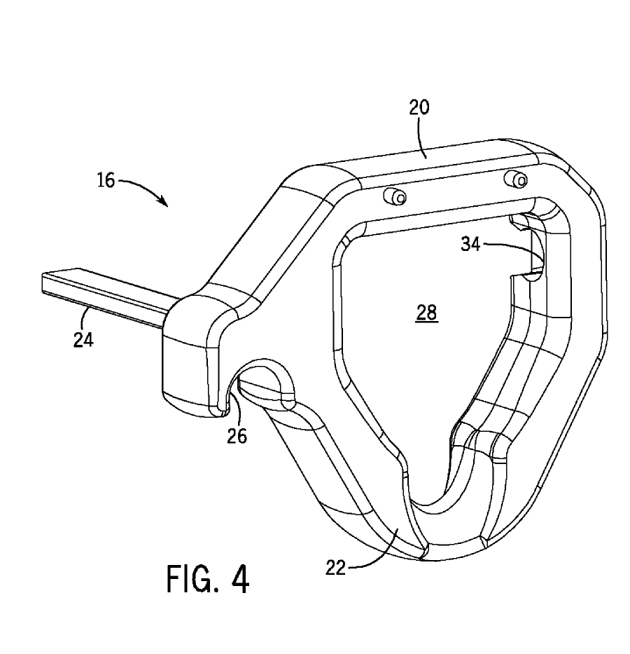

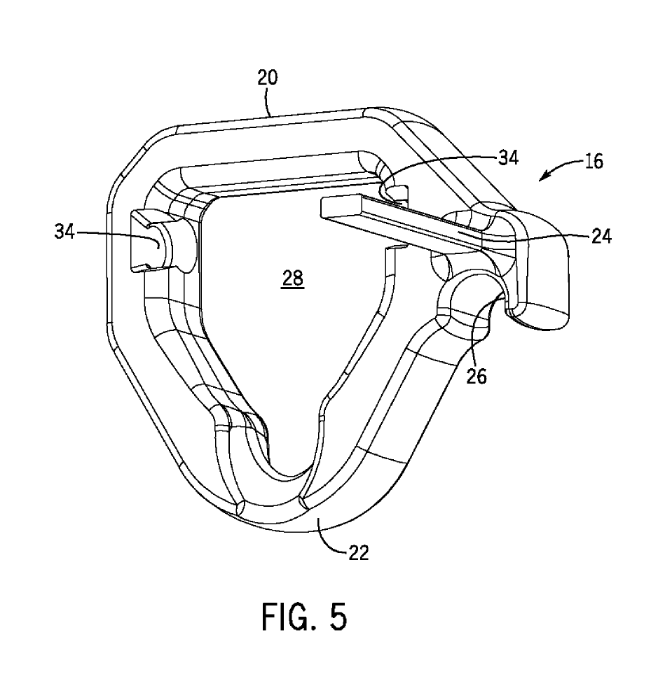

Looking now at FIGS. 1-5, the main body 16 is formed of a suitable, and preferably lightweight material, such as a metal, plastic, rubber or silicone material, or a combination thereof, with a plastic or rubber material being preferred. While the main body 16 is able to be formed with any desired shape, in one embodiment it is formed with a generally square cross-sectional shape. In another embodiment, the main body 16 is formed with a pentagonal shape, having a flat upper end 20 and a triangular lower end 22. The main body 16 also includes a projection 24 extending outwardly from one side of the main body 16, to which the sleeve 14 is secured. Additionally, to facilitate the alignment of a fishing line (not shown) on the rod 12 with the assembly 10, the main body 16 can have an eyelet 26 disposed on the projection 24 to guide the fishing line.

Within the opening 28 formed by the main body 16 is positioned a pivot arm 30. The arm 30 has a pair of opposed ends 32 that are each secured within a pair of aligned slots 34 disposed in opposite sides of the main body 16 adjacent the upper end 20. The arm 30 supports an attachment member or ring 36 that is suspended within the opening 28 to move within the opening 28 along with the pivot arm 30.

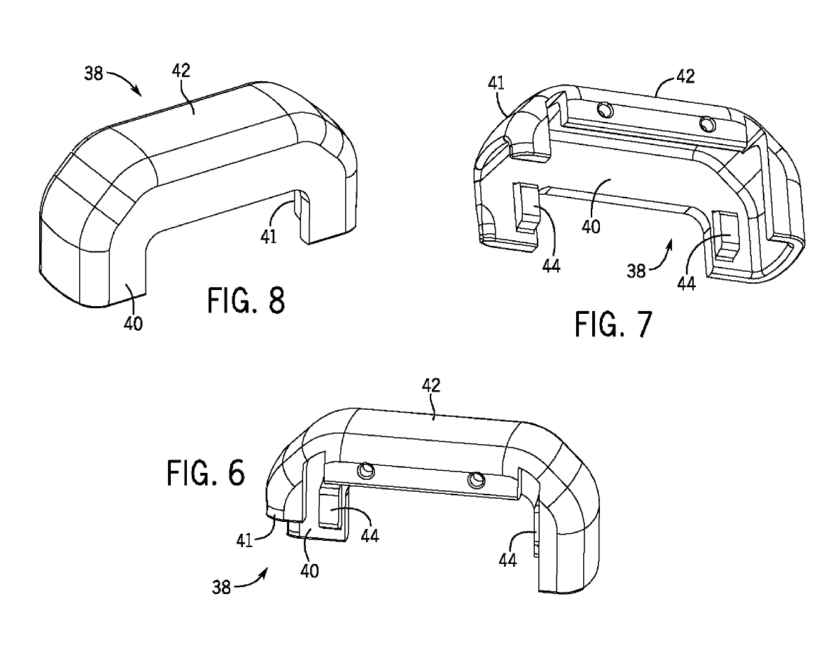

The ends 32 of the arm 30 are retained within the slots 34 by a locking clip 38 secured to the main body 16 over the upper end 20 of the main body 16. The clip 38, as best shown in FIGS. 1-3, 6 and 7, is formed to have a shape complementary to the upper end 20 of the main body 16, with a generally U-shaped configuration. The clip 38 is formed of any suitable material, such as a lightweight plastic material, and includes a pair of opposed downwardly depending walls 40, 41 extending from a central wall 42. The wall 41 located opposite the sleeve 18 is formed to be smaller than the opposed wall 40 in order to prevent the wall 41 from obstructing the opening 28 and the pivoting movement of the arm 30 and ring 36.

The wall 40 extends downwardly a sufficient distance to cover the slots 34 formed in the main body 16. Additionally, the wall 40 includes a pair of tabs 44 that are insertable within the slots 34 when the clip 38 is properly secured to the main body 16. The tabs 44 operate to retain the clip 38 on the main body 16 and to hold the pivot arm 30 within the slots 34. The tabs 44 provide this function by extending only partially into the slots 34, leaving sufficient space at the innermost end of the slots 34 for the ends 32 of the arm to rotate or pivot freely with respect to the main body 16. However, because the length of the arm 30 is greater than the width of the opening 28, the arm 30 is securely retained within the slots 34 by the tabs 44.

Looking now at FIGS. 1-3, an indicator 46 is positioned within the attachment ring 36 for movement with the ring 36 and pivot arm 30. The indicator 46 may have any particular shape or configuration that is engageable with the ring 36, but in one embodiment is formed to be generally tubular in shape such that the indicator can be inserted directly into the ring 36. The diameter of the indicator 46 is slightly larger than that of the ring 36 in order to provide a suitable frictional engagement between the indicator 46 and the ring 36 to hold the indicator 46 in the desired position. However, the amount of engagement between the indicator 46 and the ring 36 is also slight enough to allow the indicator 46 to be adjustably positioned within the ring 36.

The indicator 46 in another embodiment is formed as a hollow tubular member, thereby reducing the overall weight of the indicator 46, and is formed to include a luminescent material, such as strontium aluminate, within the material forming the indicator 46, or alternatively as the entirety of the material forming the indicator 46. The luminescent material provides increased visibility to the indicator 46 to enable an individual to more easily see the indicator 46 and the particular position of the indicator 46.

In one embodiment of the assembly 10, opposite the ring 36, the indicator 46 is optionally secured to a counterweight 48. The counterweight 48 can have any desired shape or form so long as it is attachable to the indicator 46. The counterweight 48 in one embodiment includes a structure 50 having a first bore 52 formed therein, and a second bore 54 formed therein but spaced from and oriented in the opposite direction from the first bore 52. The first bore 52 receives the end of the indicator 46 to affix the structure 50 to the indicator 46, such as by frictional, adhesive or other mechanical engagement between the indicator 46 and the structure 50. The second bore 54 receives an extension or post 56 therein, which can also be weighted to form a part of the counterweight, or which can be a separate component. The post 56 is engaged within the second bore 54 in a manner similar to the engagement of the indicator 46 within the first bore 52, and the post 56 can optionally support a fishing line guide 58, such as an eyelet, opposite the second bore 54. The eyelet 58 further assists in guiding the fishing line (not shown) on the pole 12, and can be formed similarly to the indicator 46 with a luminescent material to function as a secondary indicator.

In operation, after the sleeve 14 is secured to the rod 12 and the line is positioned within the eyelets 26, 58, the indicator 46 is adjustably positioned with respect to the ring 35, such as by sliding the indicator 46 within the ring 36, to place the indicator 46 and counterweight 48 at the desired balance position to accommodate for the type of fish being caught and the particular line and/or lures being utilized. In this configuration, once a fish strikes the line with a sufficient force, the pull on the line will cause the indicator 36 and counterweight 48 to pivot downwardly with respect to the main body 16 and the pole 12, thereby providing a visual indication of the strike. Additionally, due to the luminescent material utilized in embodiments of the indicator 46 and the eyelet 58, if present, this provides a clear indication of the strike even in low light conditions.

In addition, in an embodiment of the bobber assembly 10, while the pivot arm 30 is movable with respect to the main body 16, there are no unattached, freely moving parts in the assembly 10 to simplify the construction and operation of the assembly 10.

Various other embodiments of the present invention are contemplated as being within the scope of the filed claims particularly pointing out and distinctly claiming the subject matter regarded as the invention.

1. A bobber assembly comprising:
a) a main body adapted to be secured to a fishing pole;
b) a pivot arm pivotally secured to the main body;
c) a locking clip secured to the main body to lock the pivot arm in place on the main body; and
d) an indicator adjustably secured to the pivot arm and engageable with a fishing line on the fishing pole.

2. The assembly of claim 1 wherein the indicator includes a luminescent material.

3. The assembly of claim 2 wherein the indicator is formed of the luminescent material.

4. The assembly of claim 1 further comprising a counterweight secured to the indicator.

5. The assembly of claim 4 wherein the counterweight comprises:
a) a structure secured to the indicator; and
b) a post secured to the structure opposite the indicator.

6. The assembly of claim 5 wherein the structure includes a pair of bores extending in opposite direction for frictionally engaging the indicator and the post.

7. The assembly of claim 5 further comprising a fishing line guide secured to the post opposite the structure.

8. The assembly of claim 7 wherein the fishing line guide includes a luminescent material.

9. The assembly of claim 1 wherein the pivot arm includes an attachment member through which the indicator extends and which secured the indicator to the pivot arm.

10. The assembly of claim 9 wherein the attachment member frictionally and slidably engages the indicator.

11. The assembly of claim 1 wherein the main body includes a pair of opposed slots that receive and retain opposed ends of the pivot arm for rotation with respect to the main body.

12. The assembly of claim 11 wherein the clip includes a pair of tabs positionable within the slots to retain the ends of the of the pivot arm therein without affecting the ability of the pivot arm to rotate within the slots.

13. The assembly of claim 1 wherein the main body includes a sleeve extending outwardly from the main body and adapted to receive the end of a fishing pole therein.

14. The assembly of claim 13 wherein the sleeve is adapted to frictionally engage the fishing pole end.

15. A method of indicating a fish strike on a fishing line comprising the steps of:
a) securing the bobber assembly of claim 1 to a fishing pole and a fishing line on the fishing pole;
b) adjusting the position of the indicator on the pivot am; and
c) placing fishing line in a body of water.
